(19) United States
(12) Patent Application Publication
(10) Pub. No.: US 2018/0333697 A1
(43) Pub. Date: Nov. 22, 2018

(54) NOVEL ORGANIC MATERIAL FOR EXTRACTING THE URANIUM FROM AN AQUEOUS SOLUTION OF PHOSPHORIC ACID, ASSOCIATED METHODS FOR EXTRACTING AND RETRIEVING THE URANIUM AND A PRECURSOR OF SUCH AN ORGANIC MATERIAL

(71) Applicant: Orano Mining, Courbevoie (FR)

(72) Inventors: Laure DEHUYSER, Limoges (FR); Hamid MOKHTARI, Boisseuil (FR); Pascal NARDOUX, Panazol (FR); Philippe MOREL, Dinsac (FR); Yvon PREVOST, Bessines Sur Gartempe (FR); Christophe ROYE, Saint-Aignan (FR)

(21) Appl. No.: 15/776,889

(22) PCT Filed: Nov. 21, 2016
(86) PCT No.: PCT/EP2016/078293

§ 371 Date: May 17, 2018

(30) Foreign Application Priority Data
Nov. 19, 2015 (FR) 1561142

(51) Int. Cl. B01J 20/26; C07F 9/40; C08F 8/40; B01J 20/32; C22B 60/02; C22B 3/24

(52) U.S. Cl. CPC B01J 20/265; C07F 9/4006; C22B 3/24; B01J 20/3219; C22B 60/0265; C08F 8/40

(57) ABSTRACT

An organic material which includes a solid polymer substrate onto which molecules having the following general formula (I) are grafted:

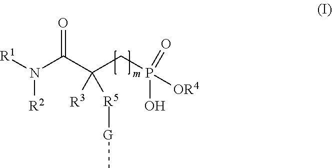

The invention also relates to the use of the organic material to extract the uranium (VI) from an aqueous acid solution, to associated methods for extracting and retrieving uranium (VI) as well as to a molecule which is a precursor of the organic material. The disclosure also relates to the use of the organic material to extract the uranium (VI) from an aqueous acid solution, to associated methods for extracting and retrieving uranium (VI) as well as to a molecule which is a precursor of the organic material.

### TECHNICAL FIELD

The present invention relates to the field concerning the extraction of uranium present in an aqueous medium containing phosphoric acid.

More particularly, it relates to an organic material allowing the extraction of uranium, and more specifically uranium in oxidation state +VI, denoted uranium(VI) or U(VI), this uranium being present in an aqueous solution also comprising phosphoric acid.

The invention also relates to a method for extracting and to a method for recovering uranium(VI) present in said aqueous solution.

The aqueous solution from which the uranium(VI) can be extracted, or from which it can be recovered, may notably be an aqueous solution resulting from the attack of a natural phosphate by sulfuric acid.

The present invention particularly finds application in the treatment of natural phosphates to recover the uranium value contained in these phosphates.

### State of the Prior Art

Natural phosphates, also called phosphate ores, are used for the production of phosphoric acid and fertilizer. They contain uranium in amounts that can vary from a few tens of ppm to several thousand ppm, as well as variable amounts of other metals.

The potential recovery of the uranium contained in these natural phosphates is a few thousand tonnes per year, this representing a non-negligible source of uranium supply.

In methods currently used to recover this uranium contained in natural phosphates, these natural phosphates are subjected to attack by sulfuric acid. This attack converts tricalcium phosphate to phosphoric acid and results in solubilising the uranium together with various other metals, in particular iron which remains the majority impurity.

The actual recovery of uranium(VI) is therefore carried out from these concentrated aqueous phosphoric acid solutions that shall be called “aqueous phosphoric acid solutions” in the remainder of the present description.

At the present time, several routes are known for extracting the uranium contained in said aqueous phosphoric acid solutions.

According to a first route, the aqueous solution containing phosphoric acid and uranium is subjected to hydrometallurgical treatment based on liquid-liquid extraction, a technique whereby this aqueous solution, or aqueous phase, is placed in contact with an organic phase comprising one or more extractants to obtain extraction, in the organic phase, of the uranium contained in the aqueous phosphoric acid solution.

However, this liquid-liquid extraction technique has recourse to substantial volumes of organic solvents which generally have very low flash points or flammability points. Said organic solvents are therefore flammable, and both the use and storage thereof can raise problems of industrial safety but also of environmental safety.

To overcome these disadvantages generated by the use of organic solvents, a second route to extract uranium has been proposed.

This second route uses solid-liquid extraction, whereby uranium is extracted from an aqueous phosphoric acid solution by contacting this aqueous solution with a water-insoluble material comprising functional chemical groups capable of retaining the uranium either by ion exchange or by chelation.

Among the proposed materials recognized as allowing the extraction of uranium from aqueous phosphoric acid solutions, particular mention can be made of the organic materials such as taught in documents U.S. Pat. No. 4,599,221 and U.S. Pat. No. 4,402,917, respectively referenced [1] and [2].

However, in these documents [1] and [2], the extraction processes require that the uranium present in oxidation state +VI in the aqueous phosphoric acid solutions resulting from sulfuric attack of natural phosphates, should be previously reduced to oxidation state +IV before it is possible to carry out actual extraction of the uranium.

It is therefore the objective of the invention to propose novel materials allowing the extraction, via the solid-liquid extraction technique, of uranium(VI) contained in an aqueous phosphoric acid solution, with a reduced number of steps.

In particular, these novel materials must not have recourse either to a reduction step of uranium(VI) to uranium(IV) prior to extraction properly so-called, but they must allow direct extraction of this uranium when present at oxidation state +VI in said aqueous phosphoric acid solutions.

The novel materials of the invention must also allow extraction of uranium(VI) that is particularly efficient irrespective of the concentration of phosphoric acid in this aqueous solution. In particular, it must be possible to use these novel materials to extract uranium(VI) from so-called “concentrated” aqueous phosphoric acid solutions, such as aqueous solutions resulting from attack of a natural phosphate by sulfuric acid having a typical phosphoric acid concentration of at least 5 mol/L.

The novel materials of the invention must also allow highly selective extraction of uranium(VI) over other metal cations likely to be contained in the aqueous phosphoric acid solution and, in particular, over iron(III).

The novel materials of the invention must also be able to be synthesised with relative ease, i.e. only having recourse to reactions conventionally performed in the field of chemical synthesis.

### DESCRIPTION OF THE INVENTION

These objectives set forth above and others are reached first with an organic material of the aforementioned type, i.e. a water-insoluble material comprising chemical functional groups capable of retaining uranium.

According to the invention, this material is an organic material comprising a solid polymeric substrate on which is covalently grafted a plurality of molecules having the following general formula (I):

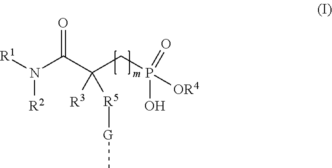

where:
m is an integer of 0, 1 or 2;
R¹ and R², the same or different, are a linear or branched, saturated or unsaturated hydrocarbon group having 6 to 12 carbon atoms;
R³ is:
   a hydrogen atom;
   a linear or branched, saturated or unsaturated hydrocarbon group having 1 to 12 carbon atoms and optionally one or more heteroatoms;
   a saturated or unsaturated hydrocarbon group comprising one or more rings of 3 to 8 carbon atoms, the ring(s) optionally comprising one or more heteroatoms; or
   an aryl group comprising one or more rings, the ring(s) optionally comprising one or more heteroatoms;
or else R² and R³ together form a group —(CH₂)ₙ— where n is an integer ranging from 1 to 4;
R⁴ is:
   a linear or branched, saturated or unsaturated hydrocarbon group having 2 to 8 carbon atoms;
   a saturated or unsaturated hydrocarbon group comprising one or more rings, the ring(s) optionally comprising one or more heteroatoms; or
   an aromatic group comprising one or more rings, the ring(s) optionally comprising one or more heteroatoms; and
R⁵ is:
   a linear or branched, saturated or unsaturated hydrocarbon group having 1 to 12 carbon atoms and optionally one or more heteroatoms;
   a saturated or unsaturated hydrocarbon group comprising one or more rings, the ring(s) optionally comprising one or more heteroatoms; or
   a hydrocarbon group comprising an aryl group possibly being formed of one or more rings, the ring(s) optionally comprising one or more heteroatoms;
R⁵ being attached to at least one group G, the group G itself being attached to the solid polymeric substrate by at least one covalent bond (represented by the dotted line), the group G being selected from among an amide group, alkenyl group, alkynyl group, amine group, thioether group, ether-oxide group and 1,2,3-triazole group.

The inventors have unexpectedly and surprisingly ascertained that an organic material comprising a solid polymeric substrate on which is covalently grafted a plurality of molecules having general formula (I) such as defined above, allows uranium(VI) to be extracted directly from an aqueous phosphoric acid solution, without a prior reduction step.

Additionally, this extraction is obtained with high performance and selectively irrespective of the concentration of phosphoric acid in this aqueous solution. More particularly, this extraction is obtained by adsorption of this uranium(VI) on the organic material.

This high extraction performance, in particular in aqueous solutions comprising a high concentration of phosphoric acid, typically higher than 5 mol/L, is all the more unexpected and surprising since it goes against the teaching of document WO 2014/127860, referenced [3], which also concerns the field of extracting uranium contained in an aqueous medium comprising phosphoric acid.

The material described in document [3] for uranium extraction is a material comprising an inorganic solid substrate on which is covalently grafted a plurality of organic molecules comprising a diamidophosphonate unit. Yet the choice of an inorganic solid substrate is presented, in document [3], as being far more preferable to the choice of an organic solid substrate, in particular on account of the greater chemical stability of a solid substrate of inorganic type.

It is specified that in the meaning of the present invention:
by “linear or branched, saturated or unsaturated hydrocarbon group having 6 to 12 carbon atoms”, it is meant any alkyl, alkenyl or alkynyl group, straight or branched chain, having 6, 7, 8, 9, 10, 11 or 12 carbon atoms;
by “linear or branched, saturated or unsaturated hydrocarbon group having 1 to 12 carbon atoms and optionally one or more heteroatoms”, it is meant any group formed by a straight or branched hydrocarbon chain having 1, 2, 3, 4, 5, 6, 7, 8, 9, 10, 11 or 12 carbon atoms, the chain possibly being saturated or, on the contrary, it may comprise one or more double or triple bonds, the chain possibly being interrupted by one or more heteroatoms or substituted by one or more heteroatoms or by one or more substituents comprising a heteroatom;
by “heteroatom”, it is meant any atom other than a carbon atom or hydrogen atom, this atom typically being a nitrogen atom, oxygen atom or sulfur atom;
by “saturated or unsaturated hydrocarbon group comprising one or more rings of 3 to 8 carbon atoms, the ring(s) optionally comprising one or more heteroatoms”, it is meant any hydrocarbon group comprising one or more rings, each ring comprising 3, 4, 5, 6, 7 or 8 carbon atoms. This or these rings may be saturated or, on the contrary, they may comprise one or more double or triple bonds, and may comprise one or more heteroatoms or be substituted by one or more heteroatoms or by one or more substituents comprising a heteroatom, this or these heteroatoms typically being N, O or S. For example, this group may notably be a cycloalkyl, cycloalkenyl or cycloalkynyl group (e.g. a cyclopropane, cyclopentane, cyclohexane, cyclopropenyl, cyclopentenyl or cyclohexenyl group), a saturated heterocyclic group (e.g. an epoxide, aziridine, tetrahydrofuryl, tetrahydropyranyl, tetrahydrothiophenyl, pyrrolidinyl or piperidinyl group), an unsaturated but non-aromatic heterocyclic group, an aromatic group or a heteroaromatic group (e.g. a pyrrolinyl, pyridinyl, furanyl or thiophenyl group);
by “aromatic group”, it is meant any group having a ring meeting Hückel's aromaticity rule and therefore having a number of delocalised electrons π of 4n+2 (e.g. a phenyl or benzyl group);
by “heteroaromatic group”, it is meant any aromatic group such as just defined but having a ring comprising one or more heteroatoms, this or these heteroatoms typically being selected from among nitrogen, oxygen and sulfur atoms (e.g. a furanyl, thiophenyl or pyrrolyl group);
by “—(CH₂)ₙ— group where n is an integer ranging from 1 to 4”, it is meant a group which may be a methylene, ethylene, propylene or butylene group;
by “linear or branched, saturated or unsaturated hydrocarbon group having 2 to 8 carbon atoms”, it is meant any alkyl, alkenyl or alkynyl group, straight or branched chain, having 2, 3, 4, 5, 6, 7 or 8 carbon atoms.

Therefore, depending on the meaning of R² and R³, the plurality of molecules of the organic material according to the invention may meet:
either the following particular formula (I-a):

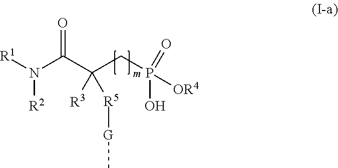

where:
m, R¹, R⁴, R⁵ and G are such as previously defined;
R² is a linear or branched, saturated or unsaturated hydrocarbon group having 6 to 12 carbon atoms; and
R³ is:
   a hydrogen atom;
   a linear or branched, saturated or unsaturated hydrocarbon group having 1 to 12 carbon atoms and optionally one or more heteroatoms;
   a saturated or unsaturated hydrocarbon group comprising one or more rings of 3 to 8 carbon atoms, the ring(s) optionally comprising one or more heteroatoms; or
   an aryl group comprising one or more rings, the ring(s) optionally comprising one or more heteroatoms.
      or the following particular formula (I-b):

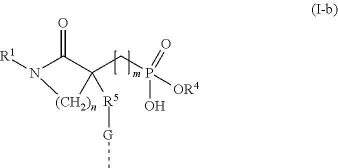

where m, n, R¹, R⁴, R⁵ and G are such as previously defined.

In one advantageous variant, the plurality of molecules of the organic material of the invention meets formula (I-a).

In one preferred variant, the plurality of molecules of the organic material of the invention meets formula (I-a) where m=0 and/or R³ is a hydrogen atom.

In particular, this plurality of molecules may particularly meet the following particular formula (I-c) where R¹, R², R⁴ and R⁵ are such as defined previously for the plurality of molecules in particular formula (I-a), m=0 and R³ is a hydrogen atom:

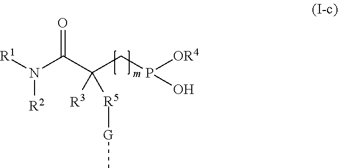

As indicated above, R⁵ is attached to at least one group G. This bond between R⁵ and G is a covalent bond.

This group G is itself attached to the solid polymeric substrate of the organic material of the invention by at least one covalent bond, this covalent bond between the group G and the solid polymeric substrate being represented by the dotted line in general formula (I) and in the particular formulas (I-a), (I-b) and (I-c) above.

Groupe G is selected from among an amide group, alkenyl group, alkynyl group, amine group, thioether group, ether-oxide group and 1,2,3-triazole group.

Table 1 below specifies, for each type of group G, the corresponding structural or condensed structural formula.

TABLE 1
Group G

| name | | corresponding formulas |
|---|---|---|
| amide | secondary amide | 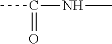 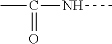 |
| | tertiary amide | 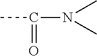 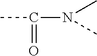 |
| alkenyl | | 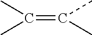 |
| alkynyl | | 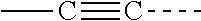 |
| amine | secondary amine | 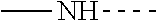 |
| | tertiary amine | 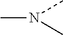 |

| | |
|---|---|
| ether-oxide | 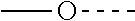 |
| thioether | 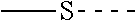 |
| 1,2,3-triazole | 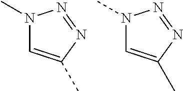 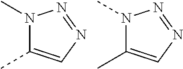 |

As illustrated in Table 1, when group G is an amide group, this group may be a secondary amide group or a tertiary amide group. In the same manner, when the group is an amine group, this group may be a secondary amine group or a tertiary amine group.

Table 1 also evidences the fact that, when group G is a secondary or tertiary amide, the polymeric solid substrate may be attached to the plurality of corresponding molecules on the carbon side or else on the nitrogen side of this amide group.

Irrespective of the group G selected, it is observed that it is capable of withstanding the operating conditions applied by the method for extracting uranium(VI) contained in an aqueous phosphoric acid solution.

In one particular variant, the plurality of molecules of the organic material of the invention meets the following particular formula (I-d):

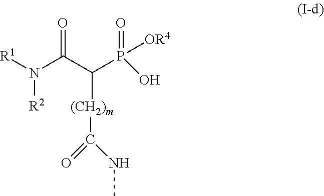

where:
n is an integer ranging from 4 to 8 carbon atoms;
R¹ and R², the same or different, are a linear or branched alkyl group having 6 to 12 carbon atoms; and
R⁴ is a linear or branched alkyl group having 3 to 6 carbon atoms.

In one variant, the groups R¹ and R² of the plurality of molecules of the organic material of the invention, irrespective of which above formula (I-a) to (I-d) they meet, are each identical and advantageously represent a branched alkyl group which may particularly comprise 8 to 10 carbon atoms. The 2-ethylhexyl group is most particularly preferred.

In one advantageous version, the plurality of molecules of the organic material of the invention meets the following particular formula (I-e):

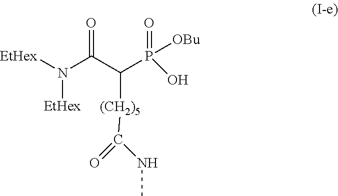

where the abbreviations “Bu” and “EtHex” respectively correspond to n-butyl and 2-ethylhexyl groups.

The organic material of the invention comprises a solid polymeric substrate. This solid polymeric substrate is formed of a polymer comprising at least one repeat unit selected from among an olefin unit, a unit comprising an aromatic group, an acrylic ester unit and mixtures of these units.

The polymer of the solid polymeric substrate is advantageously a divinylbenzene/styrene copolymer or an acrylic ester polymer.

As previously indicated, irrespective of the group G selected to ensure the covalent bond between the solid polymeric substrate and the plurality of molecules, the organic material of the invention has particularly high affinity and high selectivity for uranium(VI) when this uranium(VI) is contained in an aqueous solution also comprising phosphoric acid.

Therefore, a second subject of the invention relates to the use of an organic material such as defined above, to extract uranium(VI) from an aqueous solution comprising phosphoric acid, it being specified that the advantageous characteristics of this organic material, such as those relating to the molecules and/or to the solid polymeric substrate, can be taken alone or in combination.

According to the invention, this aqueous solution may comprise phosphoric acid over a very broad range of molar concentrations.

More particularly, the aqueous solution may comprise at least 0.1 mol/L, advantageously from 1 mol/L to 10 mol/L, preferably from 2 mol/L to 9 mol/L and more preferably from 3 mol/L to 7 mol/L of phosphoric acid.

Said aqueous solution may particularly be a solution resulting from attack of a natural phosphate by sulfuric acid.

A third subject of the invention relates to a method for extracting uranium(VI) from an aqueous solution comprising phosphoric acid, said aqueous solution in particular possibly being a solution resulting from attack of a natural phosphate by sulfuric acid.

According to the invention, this method comprises:
placing the aqueous solution in contact with an organic material such as defined above, the advantageous characteristics of this organic material possibly being taken alone or in combination; then
separating the aqueous solution and the organic material, after which the uranium(VI) is adsorbed on the organic material.

A fourth subject of the invention relates to a method for recovering uranium(VI) from an aqueous solution comprising phosphoric acid, said aqueous solution in particular possibly being a solution resulting from the attack of a natural phosphate by sulfuric acid.

According to the invention, this method comprises:
(a) extracting uranium(VI) from the aqueous solution, extraction comprising the placing of the aqueous solution in contact with an organic material such as defined above, the advantageous characteristics of this organic material possibly being taken alone or in combination, followed by separation of the aqueous solution and the organic material; and
(b) stripping uranium(VI) from the organic material obtained after step (a), stripping comprising the placing of the organic material obtained after step (a) in contact with a basic aqueous solution, followed by separation of the organic material and the basic aqueous solution, after which uranium(VI) is recovered in the basic aqueous solution.

A fifth subject of the invention relates to a molecule able to be grafted onto a solid polymeric substrate and to form an organic material such as defined above.

According to the invention, the molecule meets the following general formula (II):

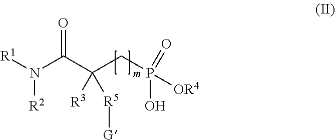

where:
m is an integer of 0, 1 or 2;
R¹ and R², the same or different, are a linear or branched, saturated or unsaturated hydrocarbon group having 6 to 12 carbon atoms;
R³ is:
   a hydrogen atom;
   a linear or branched, saturated or unsaturated hydrocarbon group having 1 to 12 carbon atoms and optionally one or more heteroatoms;
   a saturated or unsaturated hydrocarbon group comprising one or more rings of 3 to 8 carbon atoms, the ring(s) optionally comprising one or more heteroatoms; or
   an aryl group comprising one or more rings, the ring(s) optionally comprising one or more heteroatoms;
or else R² and R³ together form a group —(CH₂)ₙ— where n is an integer ranging from 1 to 4;
R⁴ is:
   a linear or branched, saturated or unsaturated hydrocarbon group having 2 to 8 carbon atoms;
   a saturated or unsaturated hydrocarbon group comprising one or more rings, the ring(s) optionally comprising one or more heteroatoms; or
   an aromatic group comprising one or more rings, the ring(s) optionally comprising one or more heteroatoms; and
R⁵ is:
   a linear or branched, saturated or unsaturated hydrocarbon group having 1 to 12 carbon atoms and optionally one or more heteroatoms;
   a saturated or unsaturated hydrocarbon group comprising one or more rings, the ring(s) optionally comprising one or more heteroatoms; or
   a hydrocarbon group comprising an aryl group possibly formed of one or more rings, the ring(s) optionally comprising one or more heteroatoms;
R⁵ being attached to at least one group G′ selected from among a thiol, azide, aldehyde, acyl chloride, alkene group, acetylene group, amine group, hydroxyl group and halide group.

Reference will be made to the different definitions given above for m and the different groups R¹ to R⁵, in connection with the organic material.

When G′ is a hydroxyl group, it may be an activated hydroxyl group, e.g. with a tosyl denoted Ts, or with a mesyl denoted Ms.

Therefore, depending on the meaning of R² and R³, the molecule of the invention may meet:
either the following particular formula (II-a):

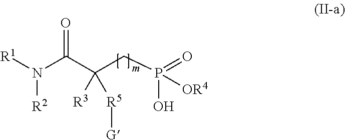

where:
m, R¹, R⁴, R⁵ and G′ are such as previously defined;
R² is a linear or branched, saturated or unsaturated hydrocarbon group having 6 to 12 carbon atoms; and
R³ is:
   a hydrogen atom;
   a linear or branched, saturated or unsaturated hydrocarbon group having 1 to 12 carbon atoms and optionally one or more heteroatoms;
   a saturated or unsaturated hydrocarbon group comprising one or more rings of 3 to 8 carbon atoms, the fines) optionally comprising one or more heteroatoms; or
   an aryl group comprising one or more rings, the ring(s) optionally comprising one or more heteroatoms.
      or the following particular formula (II-b):

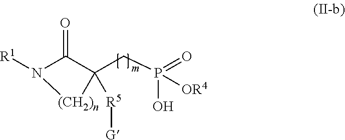

where m, n, R¹, R⁴, R⁵ and G′ are such as previously defined.

In one advantageous variant, the molecule of the invention meets formula (II-a).

In one preferred variant, the molecule of the invention meets formula (II-a) where m=0 and/or R³ is a hydrogen atom.

In particular, this molecule may meet the following particular formula (II-c), where R¹, R², R⁴ and R⁵ are such as previously defined for the molecule in the particular formula (II-a), m=0 and R³ is a hydrogen atom:

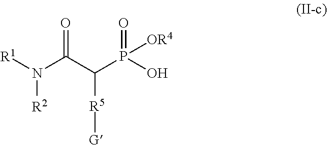

As indicated above, R⁵ is attached to at least one group G′. This bond between R⁵ and G′ is a covalent bond.

Group G′ is selected from among a thiol, azide, aldehyde, acyl chloride, acetylene group, alkene group, amine group, hydroxyl group and halide group.

Table 2 below specifies, for each type of group G′, the corresponding condensed structural formula.

TABLE 2
Group G′

| | |
|---|---|
| name | corresponding formulas |

| aldehyde | | 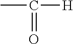 |
|---|---|---|
| acyl chloride | | 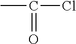 |
| alkene | | 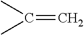 |
| acetylene | | —C≡CH |
| amine | primary amine | —NH₂ |
| | secondary amine | —NH— |

| | |
|---|---|
| hydroxyl | —OH |
| activated hydroxyl | OTs or OMs |
| halide | —X with X = Cl, Br, I, F |
| azide | —N₃ |
| thiol | —SH |

As illustrated in Table 2, when group G′ is an amine group, this group may be a primary amine group or a secondary amine group.

In one particular variant, the molecule of the invention meets the following particular formula (II-d):

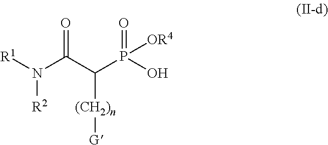

where:
G′ is such as previously defined;
n is an integer ranging from 4 to 8 carbon atoms;
R¹ and R², the same or different, are a linear or branched alkyl group having 6 to 12 carbon atoms; and
R⁴ is a linear or branched alkyl group having 3 to 6 carbon atoms.

In one variant, the groups R¹ and R² of the molecule of the invention, irrespective of which above particular formula (II-a) to (II-d) they meet, are each identical and advantageously represent a branched alkyl group that may in particular comprise S to 10 carbon atoms. The 2-ethylhexyl group is most particularly preferred.

In one advantageous version, the molecule of the invention meets the following particular formula (II-e):

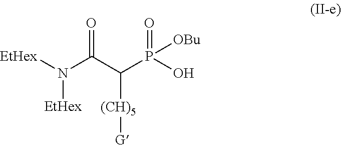

where the abbreviations “Bu” and “EtHex” respectively correspond to n-butyl and 2-ethylhexyl groups.

A sixth subject of the invention relates to the use of a specific molecule as precursor for the synthesis of the organic material of the invention.

The specific molecule that is the subject of this use meets the following general formula (III):

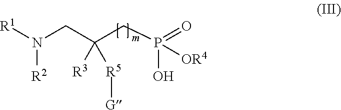

where:
m is an integer of 0, 1 or 2;
R¹ and R², the same or different, are a linear or branched, saturated or unsaturated hydrocarbon group having 6 to 12 carbon atoms;
R³ is:
   a hydrogen atom;
   a linear or branched, saturated or unsaturated hydrocarbon group having 1 to 12 carbon atoms and optionally one or more heteroatoms;
   a saturated or unsaturated hydrocarbon group comprising one or more rings of 3 to 8 carbon atoms, the ring(s) optionally comprising one or more heteroatoms; or
   an aryl group comprising one or more rings, the ring(s) optionally comprising one or more heteroatoms;
or else R² and R³ together form a group —(CH₂)ₙ— where n is an integer ranging from 1 to 4;
R⁴ is:
   a linear or branched, saturated or unsaturated hydrocarbon group having 2 to 8 carbon atoms;
   a saturated or unsaturated hydrocarbon group comprising one or more rings, the ring(s) optionally comprising one or more heteroatoms; or
   an aromatic group comprising one or more rings, the ring(s) optionally comprising one or more heteroatoms; and
R⁵ is:
   a linear or branched, saturated or unsaturated hydrocarbon group having 1 to 12 carbon atoms and optionally one or more heteroatoms;
   a saturated or unsaturated hydrocarbon group comprising one or more rings, the ring(s) optionally comprising one or more heteroatoms; or
   a hydrocarbon group comprising an aryl group possibly formed of one or more rings, the ring(s) optionally comprising one or more heteroatoms;
R⁵ being attached to at least one group G″ selected from among a thiol, azide, aldehyde, carboxylic acid, acyl chloride, alkene group, acetylene group, amine group, hydroxyl group and halide group.

Reference can be made to the different definitions given above for m and the different groups R¹ to R⁵, in connection with the organic material.

The invention particularly concerns the use, as synthesis precursor of the organic material of the invention, of the molecule of the invention such as described above and meeting the general formula (II) and/or the particular formulas (II-a) to (II-e), the advantageous characteristics of this molecule able to be taken alone or in combination.

In fact, the specific molecule that meets the general formula (II), (Ill) and/or the particular formulas (II-a) to (II-e), can be grafted onto a solid polymeric substrate to form an organic material such as defined above.

Therefore, conforming to the invention, the covalent grafting of these specific molecules of general formula (III) and/or (II) onto the solid polymeric substrate can be obtained using a method, optionally in a single step, allowing the group or groups G″ or G′ of the specific molecule, including that of the invention, to react with one or more reactive functions belonging to the solid polymeric substrate, via implementation of conventional reactions in the field of chemical synthesis.

Such reactions between the group or groups G″ or G′ with the reactive function(s) present on the solid polymeric substrate to form the covalent bond(s) can be conducted in particular via substitution, addition, or cycloaddition.

Other characteristics and advantages of the invention will become apparent on reading the following additional description given with reference to appended FIGS. 1 and 2, this description relating to an example of synthesis of a molecule of which the use, as synthesis precursor of the organic material, conforms to the invention, and also relating to an example of synthesis of an organic material of the invention from the molecule synthesised in the preceding example.

Evidently, these examples are only given to illustrate the subject of the invention and do not in any manner limit this subject-matter.

### BRIEF DESCRIPTION OF THE DRAWINGS

FIG. 1 schematically illustrates the synthesis of a molecule, denoted 11, meeting general formula (III) where R¹ and R² are both a 2-ethylhexyl group denoted “EtHex”, R³ is H, R⁴ is an n-butyl group denoted “Bu”, R⁵ is a group —(CH₂)₅— and G″ is a carboxylic acid C(O)—OH. It is specified that in FIG. 1 the methyl group is denoted “Me”.

FIG. 2 schematically illustrates the preparation of an organic material of the invention comprising a solid polymeric substrate formed of a functionalised divinylbenzene/styrene copolymer and on which the molecule 11 illustrated in FIG. 1 has been grafted.

### DETAILED DESCRIPTION OF PARTICULAR EMBODIMENTS

### Example 1: Synthesis of a Molecule of the Invention

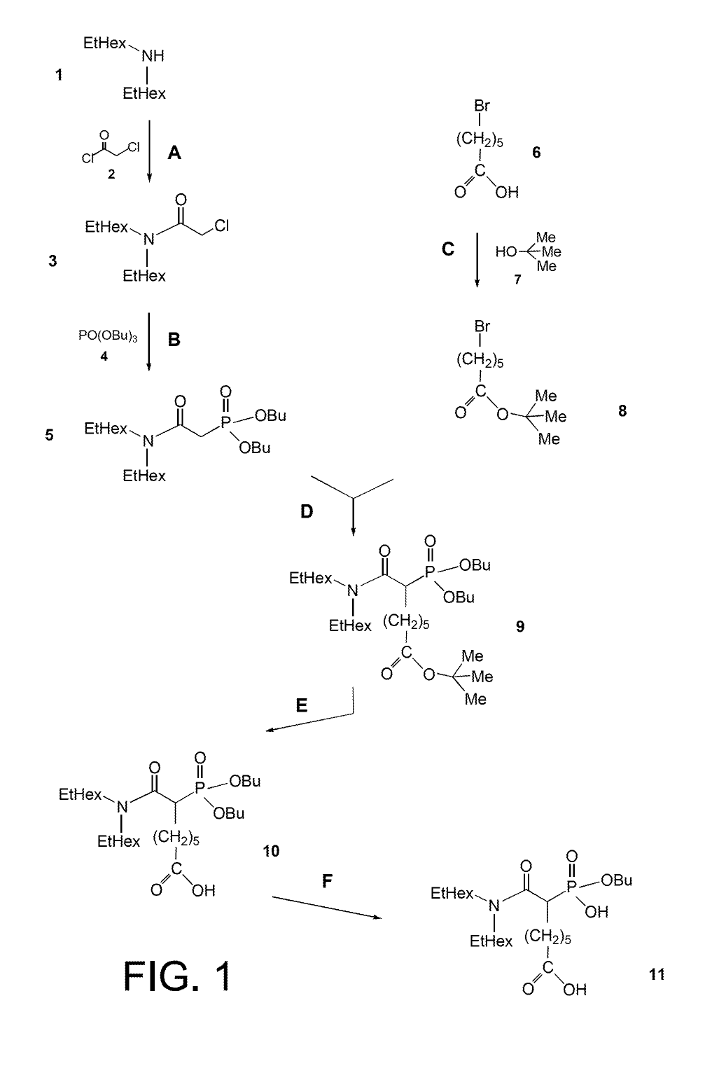

The molecule 11 was synthesised in accordance with the reaction scheme illustrated in FIG. 1.

As illustrated in this FIG. 1, the synthesis of dibutyl 1-(N,N-diethylhexylcarbamoyl)methylphosphonate, on the one hand, and the synthesis of tert-butyl 6-bromohexanoate, on the other hand, were first performed.

1.1 Synthesis of Dibutyl 1-(N,N-Diethylhexylcarbamoyl)-Methylphosphonate

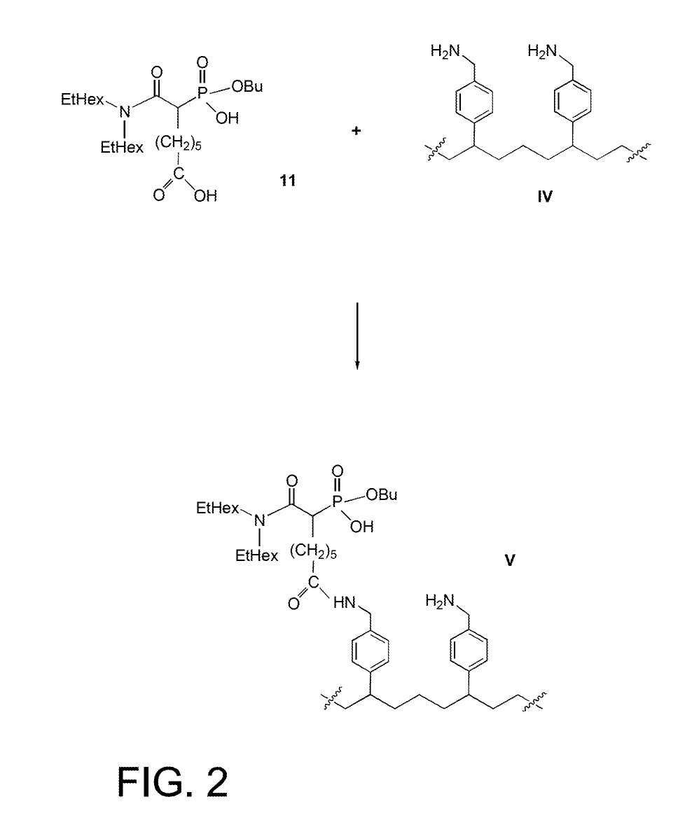

The synthesis of dibutyl 1-(N,N-diethylhexylcarbamoyl)-methylphosphonate can be carried out in particular in accordance with the teaching of document WO 2013/167516, referenced [4], or by implementing steps A and then B of the protocol described in Chapter 1.1 of Example 1 with reference to FIG. 1, or by implementing steps A then B of the protocol described in Chapter 1.2 of this same Example 1 with reference to FIG. 2 of this document [4].

At a first step, denoted A, 2,2′-diéthylhexylamine, denoted 1, is caused to react with chloroacetyl chloride, denoted 2, to obtain 2-chloro-N,N-diethylhexylacetamide, denoted 3. This reaction A can particularly be conducted in the presence of dichloromethane and potassium carbonate.

At a second step, denoted B, 2-chloro-N,N-diethylhexylacetamide 3 is caused to react with tributylphosphite, denoted 4, to obtain dibutyl 1-(N,N-diethylhexylcarbamoyl)methylphosphonate, denoted 5.

1.2 Synthesis of Tert-Butyl 6-Bromohexanoate

This synthesis is conducted in one step, denoted C, by causing 6-bromohexanoic acid, denoted 6, to react in the presence of tert-butanol, denoted 7, with dicyclohexylcarbodiimide (DCC) to obtain tert-butyl 6-bromohexanoate, denoted 8.

This step C provides protection of the carboxylic acid function of compound 6, thereby minimising secondary reactions.

1.3 Synthesis of the Molecule 11

First, at an alkylation step denoted D, dibutyl 1-(N,N-diethylhexylcarbamoyl)methylphosphonate 5 is caused to react with tert-butyl 6-bromohexanoate 8, previously synthesised, to obtain tert-butyl 1-(N,N-diethylhexyl-7-dibutoxyphosphoryl)-8-oxooctanoate, denoted 9.

A first saponification step, denoted E, is then performed, to deprotect the carboxylic acid and to obtain 1-(N,N-diethylhexyl-7-dibutoxyphosphoryl)-8-oxooctanoic acid 10, followed by a second mono-saponification step, denoted F, allowing the molecule 11, which corresponds to 1-(N,N-diethylhexyl-7-butoxyhydroxyphosphoryl)-8-oxooctanoic acid, to be obtained.

### Example 2: Preparation of an Organic Material of the Invention

A solid polymeric substrate formed by a divinylbenzene/styrene copolymer was first functionalised with amine functions to obtain the functionalised solid polymeric substrate denoted IV in FIG. 2.

The molecule 11 was then grafted via peptide coupling onto all or part of the amine functions of the functionalised solid polymeric substrate, to obtain an organic material conforming to the invention and denoted V in FIG. 2.

### BIBLIOGRAPHY

[1] U.S. Pat. No. 4,599,221
[2] U.S. Pat. No. 4,402,917
[3] WO 2014/127860 A1
[4] WO2013/167516 A1

What is claimed is:

1. Organic material comprising a solid polymeric substrate on which is covalently grafted a plurality of molecules having the general following (I) below: 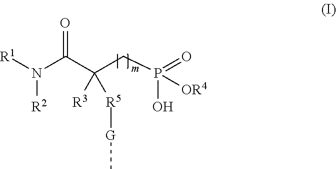
where:
m is an integer of 0, 1 or 2;
R¹ and R², the same or different, are a linear or branched, saturated or unsaturated hydrocarbon group having 6 to 12 carbon atoms;
R³ is:
a hydrogen atom;
a linear or branched, saturated or unsaturated hydrocarbon group having 1 to 12 carbon atoms and optionally one or more heteroatoms;
a saturated or unsaturated hydrocarbon group comprising one or more rings of 3 to 8 carbon atoms, the ring(s) optionally comprising one or more heteroatoms; or
an aryl group comprising one or more rings, the ring(s) optionally comprising one or more heteroatoms;
or else R² and R³ together form a group —(CH₂)ₙ— where n is an integer ranging from 1 to 4;
R⁴ is:
a linear or branched, saturated or unsaturated hydrocarbon group having 2 to 8 carbon atoms;
a saturated or unsaturated hydrocarbon group comprising one or more rings, the ring(s) optionally comprising one or more heteroatoms; or
an aromatic group comprising one or more rings, the ring(s) optionally comprising one or more heteroatoms; and
R⁵ is:
a linear or branched, saturated or unsaturated hydrocarbon group having 1 to 12 carbon atoms and optionally one or more heteroatoms;
a saturated or unsaturated hydrocarbon group comprising one or more rings, the ring(s) optionally comprising one or more heteroatoms; or
a hydrocarbon group comprising an aryl group possibly formed of one or more rings, the ring(s) optionally comprising one or more heteroatoms;
R⁵ being attached to at least one group G, the group G itself being attached to the solid polymeric substrate by at least one covalent bond (represented by the dotted line), the group G being selected from among an amide group, alkenyl group, alkynyl group, amine group, thioether group, ether-oxide group and 1,2,3-triazole group.

2. The organic material according to claim 1, wherein the plurality of molecules meets the following particular formula (I-a): 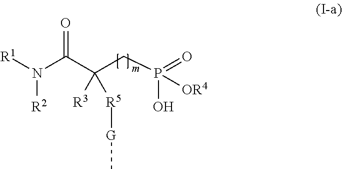
where:
R² is a linear or branched, saturated or unsaturated hydrocarbon group having 6 to 12 carbon atoms; and
R³ is:
a hydrogen atom;
a linear or branched, saturated or unsaturated hydrocarbon group having 1 to 12 carbon atoms and optionally one or more heteroatoms;
a saturated or unsaturated hydrocarbon group comprising one or more rings of 3 to 8 carbons atoms, the ring(s) optionally comprising one or more heteroatoms; or
an aryl group comprising one or more rings, the ring(s) optionally comprising one or more heteroatoms.

3. The organic material according to claim 2, wherein the plurality of molecules meets the particular formula (I-a) where m=0 and R³ is a hydrogen atom.

4. The organic material according to claim 3, wherein the plurality of molecules meets the following particular formula (I-d): 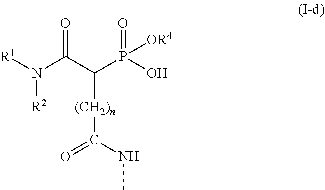
where:
n is an integer ranging from 4 to 8 carbon atoms;
R¹ and R², the same or different, are a linear or branched alkyl group having 6 to 12 carbon atoms; and
R⁴ is a linear or branched alkyl group having 3 to 6 carbon atoms.

5. The organic material according to claim 1, wherein R¹ and R² are each the same and represent a branched alkyl group having 8 to 10 carbon atoms.

6. The organic material according to claim 5, wherein the plurality of molecules meets the following particular formula (I-e):

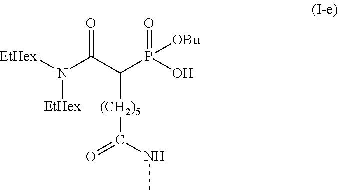

7. The organic material according to claim 1, wherein the solid polymeric substrate is formed of a polymer comprising at least one repeat unit selected from among an olefin unit, a unit comprising an aromatic group, an acrylic ester unit and mixtures of these units, this polymer advantageously being a divinylbenzene/styrene copolymer or an acrylic ester polymer.

8. Use of an organic material according to claim 1, to extract uranium(VI) from an aqueous solution comprising phosphoric acid, in particular from a solution resulting from attack of a natural phosphate by sulfuric acid.

9. Method for extracting uranium(VI) from an aqueous solution comprising phosphoric acid, which comprises placing the aqueous solution in contact with an organic material according to claim 1, followed by separation of the aqueous solution and the organic material.

10. Method for recovering uranium(VI) from an aqueous solution comprising phosphoric acid, which comprises:
(a) extracting uranium(VI) from the aqueous solution, extraction comprising the placing of the aqueous solution in contact with an organic material according to claim 1, followed by separation of the aqueous solution and the organic material; and
(b) stripping the uranium(VI) from the organic material obtained after step (a), stripping comprising the placing in contact of the organic material obtained after step (a) with a basic aqueous solution, followed by separation of the organic material and the basic aqueous solution.

11. The extraction method according to claim 9, wherein the aqueous solution is a solution resulting from attack of a natural phosphate by sulfuric acid.

12. Molecule meeting the following general formula (II): 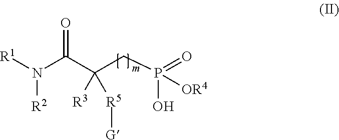
where:
m is an integer of 0, 1 or 2;
R¹ and R², the same or different, are a linear or branched, saturated or unsaturated hydrocarbon group having 6 to 12 carbon atoms;
R³ is:
a hydrogen atom;
a linear or branched, saturated or unsaturated hydrocarbon group having 1 to 12 carbon atoms and optionally one or more heteroatoms;
a saturated or unsaturated hydrocarbon group comprising one or rings of 3 to 8 carbon atoms, the ring(s) optionally comprising one or more heteroatoms; or
an aryl group comprising one or more rings, the ring(s) optionally comprising one or more heteroatoms;
or else R² and R³ together form a group —(CH₂)ₙ— where n is an integer ranging from 1 to 4;
R⁴ is:
a linear or branched, saturated or unsaturated hydrocarbon group having 2 to 8 carbons atoms;
a saturated or unsaturated hydrocarbon group comprising one or more rings, the ring(s) optionally comprising one or more heteroatoms; or
an aromatic group comprising one or more rings, the ring(s) optionally comprising one or more heteroatoms; and
R⁵ is:
a linear or branched, saturated or unsaturated hydrocarbon group having 1 to 12 carbon atoms and optionally one or more heteroatoms;
a saturated or unsaturated hydrocarbon group comprising one or more rings, the ring(s) optionally comprising one or more heteroatoms; or
a hydrocarbon group comprising an aryl group possibly formed of one or more rings, the ring(s) optionally comprising one or more heteroatoms;
R⁵ being attached to at least one group G′ selected from among a thiol, azide, aldehyde, acyl chloride, alkene group, acetylene group, amine group, hydroxyl group and halide group.

13. The molecule according to claim 12, meeting the following particular formula (II-a): 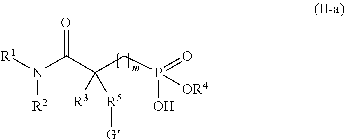
where:
R² is a linear or branched, saturated or unsaturated hydrocarbon group having 6 to 12 carbon atoms; and
R³ is:
a hydrogen atom;
a linear or branched, saturated or unsaturated hydrocarbon group having 1 to 12 carbon atoms and optionally one or more heteroatoms;
a saturated or unsaturated hydrocarbon group comprising one or more rings of 3 to 8 carbon atoms, the ring(s) optionally comprising one or more heteroatoms; or
an aryl group comprising one or more rings, the ring(s) optionally comprising one or more heteroatoms.

14. The molecule according to claim 13 meeting the particular formula (II-a) where m=0 and R³ is a hydrogen atom.

15. The molecule according to claim 14 meeting the following particular formula (II-d): 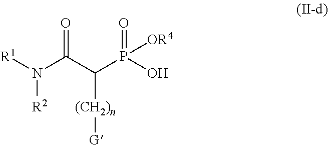
where:
n is an integer ranging from 4 to 8 carbon atoms;
R¹ and R², the same or different, are a linear or branched alkyl group having 6 to 12 carbon atoms; and
R⁴ is a linear or branched alkyl group having 3 to 6 carbon atoms.

16. The molecule according to claim 12, wherein R¹ and R² are each the same and represent a branched alkyl group having 8 to 10 carbon atoms.

17. The molecule according to claim 16 meeting the following particular formula (II-e):

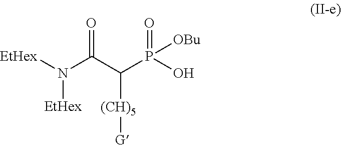

18. Use of a molecule meeting the following general formula (III): 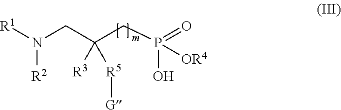
where:
m is an integer of 0, 1 or 2;
R¹ and R², the same or different, are a linear or branched, saturated or unsaturated hydrocarbon carbon group having 6 to 12 carbon atoms;
R³ is:
a hydrogen atom;
a linear or branched, saturated or unsaturated hydrocarbon group having 1 to 12 carbon atoms and optionally one or more heteroatoms;
a saturated or unsaturated hydrocarbon group comprising one or more rings of 3 to 8 carbon atoms, the ring(s) optionally comprising one or more heteroatoms; or
an aryl group comprising one or more rings, the ring(s) optionally comprising one or more heteroatoms;
or else R² and R³ together form a group —(CH₂)ₙ— where n is an integer ranging from 1 to 4;
R⁴ is:
a linear or branched, saturated or unsaturated hydrocarbon group having 2 to 8 carbon atoms;
a saturated or unsaturated hydrocarbon group comprising one or more rings, the ring(s) optionally comprising one or more heteroatoms; or
an aromatic group comprising one or more rings, the ring(s) optionally comprising one or more heteroatoms; and
R⁵ is:
a linear or branched, saturated or unsaturated hydrocarbon group having 1 to 12 carbon atoms and optionally one or more heteroatoms;
a saturated or unsaturated hydrocarbon group comprising one or more rings, the ring(s) optionally comprising one or more heteroatoms; or
a hydrocarbon group comprising an aryl group possibly being formed of one of more rings, the ring(s) optionally comprising one or more heteroatoms;
R⁵ being attached to at least one group G″ selected from among a thiol, azide, aldehyde, carboxylic acid, acyl chloride, alkene group, acetylene group, amine group, hydroxyl group and halide group
as synthesis precursor of the organic material according to claim 1.

19. The recovery method according to claim 10, wherein the aqueous solution is a solution resulting from attack of a natural phosphate by sulfuric acid.
